(19) United States
(12) Patent Application Publication
(10) Pub. No.: US 2012/0086707 A1
(43) Pub. Date: Apr. 12, 2012

(54) 3-DIMENSION DISPLAY DEVICE

(76) Inventors: Ra-Bin Li, Tainan County (TW); Heng-Cheng Tseng, Chiayi County (TW); Mu-Kai Kang, Pingtung County (TW)

(21) Appl. No.: 12/970,965

(22) Filed: Dec. 17, 2010

(30) Foreign Application Priority Data
Oct. 12, 2010 (TW) 099134702

(51) Int. Cl. G06T 15/00

(52) U.S. Cl. 345/419

(57) ABSTRACT

A phase switch component driven synchronously is configured at a light emitting side of a display panel of a display. A plurality of parallel electrodes is disposed on a conductive film of the phase switch component, each corresponding to one of a plurality of rows of display pixel driven by gate drivers of the display panel. When the display panel sequentially drives the pixel electrodes of each row of display pixel, by line scanning way, to output frames of 3-dimension images, the phase switch component is synchronously driven to switch the phase of liquid crystals by each parallel electrodes and alters the frames to be polarized lights capable of being received by a left part and a right part of 3D glasses respectively.

### BACKGROUND OF THE INVENTION

1. Field of the Invention

The invention relates to a 3-dimension display device, and more particularly, to a 3-dimension display device that dynamically outputs alternating left and right frames via a phase switch component.

2. Description of the Prior Art

Three dimensional display technologies has evolved for decades with many types of applications widespread nowadays, such as active glasses technology, passive glasses technology, color glasses, polarizing glasses, head mounted display (HMD), bare eye technology, spatial multiplex and time multiplex of flat panel display . . . etc.

Of all the present technologies, the active glasses technology, or shutter glasses, teaches that a display provides images alternately for the left eye and the right eye with twiced frequency. Wearing the shutter glasses, the left eye and the right eye of a user are dynamically blocked. In such way, the right eye will be blocked as the display is providing images for the left eye, and the left eye will be blocked as the display is providing images for the right eye, which therefore generates visual perception of 3-dimensional effect.

Another commonly adapted technology reveals that an interlaced polarizer is added to a display panel, where half of the pixels on the panel, for example, the pixels of odd rows, display images for the left eye, and half of the pixels on the panel, for example, the pixels of even rows, display images for the right eye. As the lights pass through the pixels of odd rows on the panel and the polarizer, those polarized lights with vertical polarization are allow to pass and be perceived by the left eye; as the lights pass through the pixels of even rows on the panel and the polarizer, those polarized lights with horizontal polarization are allow to pass and be perceived by the right eye. As for the user, a pair of linear polarized glasses with vertically polarized left lens and horizontally polarized right lens allow the user to see the left images with his/her left eye and the right images his/her right eye.

However, the shutter glasses also has drawbacks, such as that it requires high cost in manufacturing, it is vulnerable to break and also cumbersome, and one pair of glasses only suits for one user. As for the display panel with interlaced polarizer, the resolution of the images is downgraded to half of its original resolution, and the alignment of the polarizer to each pixel rows is often a delicate situation.

### SUMMARY OF THE INVENTION

The invention provides a 3-dimension display device, which is utilized for providing one or more pairs of polarized glasses to alternately receive polarized lights corresponding to a left part and a right part of the polarized glasses. The display device includes a display panel and a phase switch component. The display panel includes a plurality of pixel rows aligning in parallel, each pixel row including a plurality of pixel electrodes for outputting the polarized lights. The phase switch component is configured at a light emitting side of the display panel. The phase switch component includes a first conductive film, a second conductive film, and a liquid crystal unit. The first conductive film and the second conductive film are configured at both sides of the liquid crystal unit respectively for being driven to switch the phase of the liquid crystal unit at a modulating frequency. The first conductive film includes a plurality of parallel electrodes parallel and not in contact with one another. Each of the parallel electrodes is respectively corresponding to each of the pixel rows. A display frequency of the display panel is synchronous with the modulating frequency of the phase switch component, which switches the phase of the polarized lights outputted by the display panel alternately between a first phase and a second phase.

The invention also provides a phase switch component used for a 3-dimension display device and configured at a light emitting side of a display panel. The display panel outputs polarized lights and includes a plurality of pixel rows, each pixel row including a plurality of pixel electrodes. The phase switch component includes a first conductive film, a second conductive film, and a liquid crystal unit. The first conductive film includes a plurality of parallel electrodes parallel with one another. Each parallel electrode is respectively corresponding to each of the pixel rows. The liquid crystal unit is configured between the first conductive film and the second conductive film. The first conductive film and the second conductive film are driven to switch the phase of the liquid crystal unit at a modulating frequency. When the phase switch component is driven, a display frequency of the display panel is synchronous with the modulating frequency of the phase switch component, which switches the phase of the polarized lights outputted by the display panel alternately between a first phase and a second phase.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a 3-dimension display device according to the invention.

FIG. 2 is a schematic diagram of a sectional view of a phase switch component.

FIG. 3 is a schematic diagram of an embodiment showing phase modulation of the display device.

FIG. 4 is a schematic diagram of another embodiment showing phase modulation of the display device.

FIG. 5 is a block diagram of the display device.

FIG. 6 is a schematic diagram showing the driving signals of the display device in a time basis.

FIG. 7 is a schematic diagram of the first conductive film corresponding to a color filter in the phase switch component.

### DETAILED DESCRIPTION

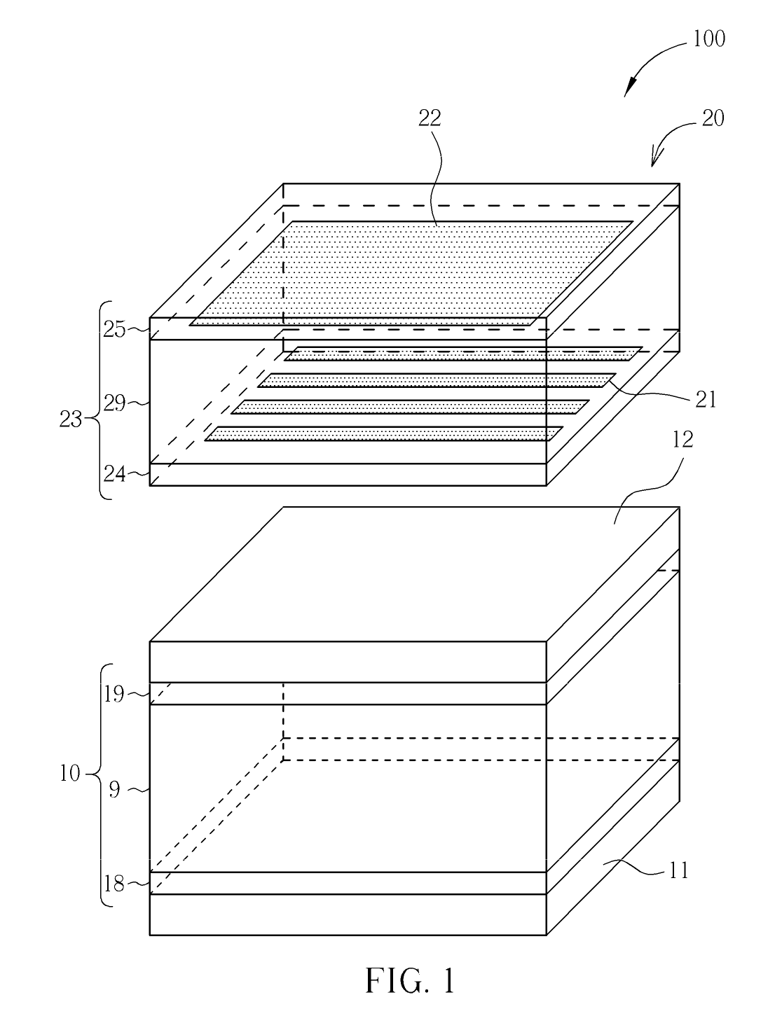

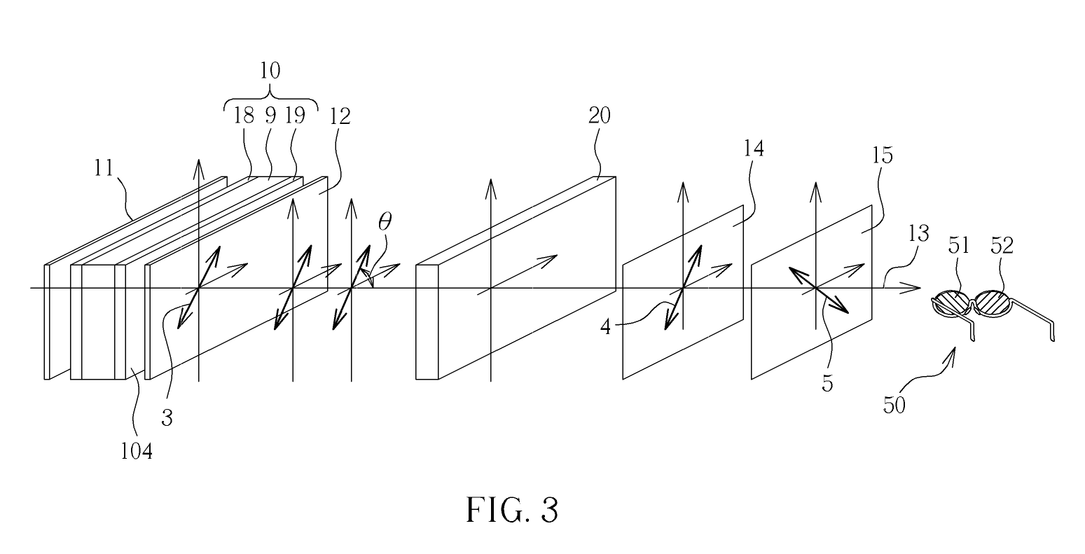

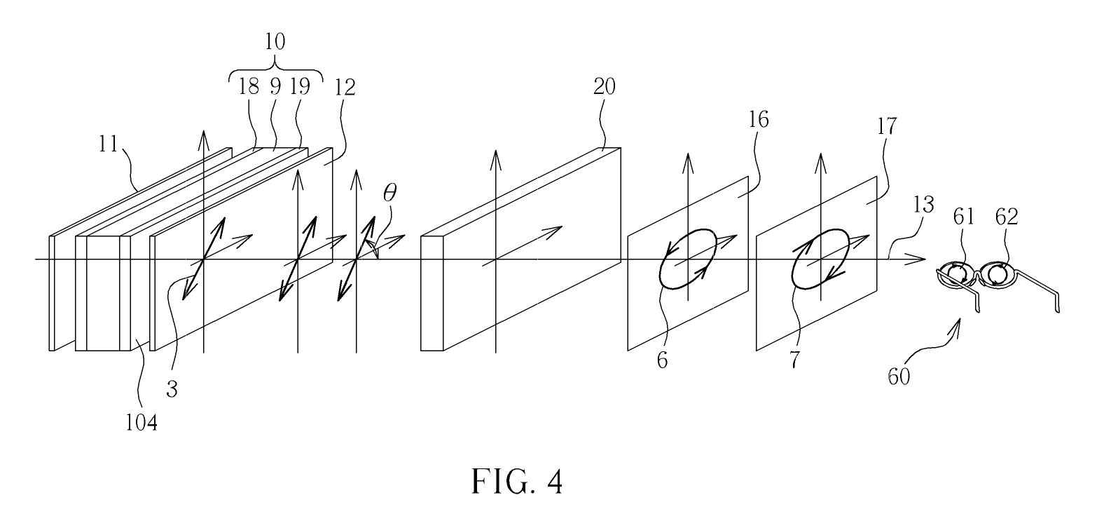

To provide high resolution 3-dimension display effect for a display device 100 and also simplify the design of 3-D glasses for end users, the display device 100 of the invention utilizes an active phase switch component at the display end to alternately output images separately corresponding to the left part and the right part of the 3-D glasses in real-time modulation. Please refer to FIG. 1, which shows a schematic diagram of the 3-dimension display device 100 according to an embodiment of the invention. The display device 100 receives and outputs 2-dimension or 3-dimension image signals. For the 3-dimension applications, the display device 100 alternately provides polarized lights for corresponding left eye and right eye, so as to ensure users who wear the polarized glasses have a visual perception of 3-dimensional images. The display device 100 includes a display panel 10 and a phase switch component 20. A first polarizer 11 and a second polarizer 12 can be configured at, but not limited to, both sides of the display panel 10, which is substantially composed by a first substrate 18 and a second substrate 19 filled with liquid crystal layer 9 therebetween. Other specific structures of the display panel 10 along with the polarizers 11, 12 can be easily understood and used by any person skilled in the art and are omitted here for brevity purpose. The phase switch component 20 is configured at a light emitting side 104, as referred to in FIG. 3 and FIG. 4, of the display panel 10, and practically, glued to the light emitting side 104 of the display panel 10.

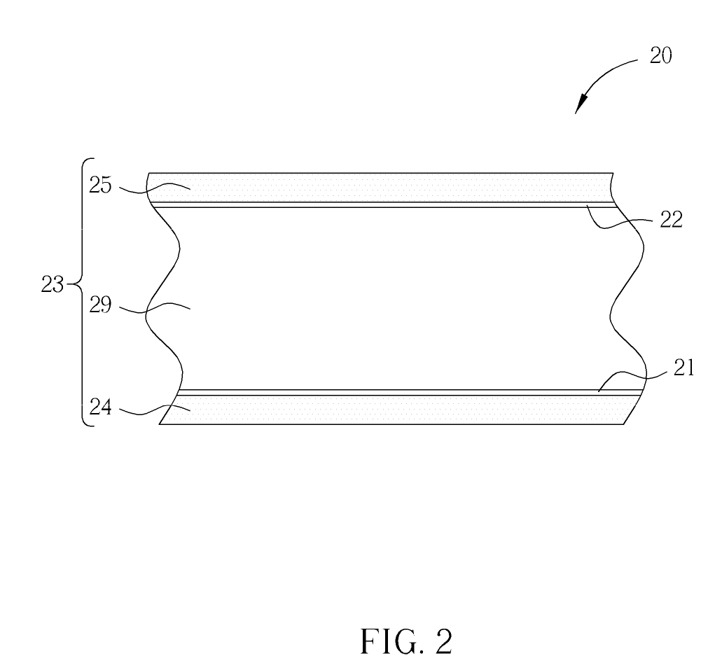

Please refer to FIG. 2. FIG. 2 is a schematic diagram showing a sectional view of an embodiment of the phase switch component 20 of the invention. The phase switch component 20 includes a first conductive film 21, a second conductive film 22, and a liquid crystal unit 23, which is substantially composed by a first substrate 24 and a second substrate 25 filled with liquid crystal layer 29 therebetween. Please also refer to FIG. 1. The first conductive film 21 and the second conductive film 22 are respectively formed on the first substrate 24 and the second substrate 25, which means at both sides of the liquid crystal unit 23 respectively, and preferably can be indium tin oxide (ITO) transparent conductive films. When electrified, the conductive films 21, 22 drive the liquid crystal unit 23 to rotate and change to various phases. Practically, to meet the requirement described in the following paragraphs, a voltage difference between the first conductive film 21 and the second conductive film 22 of the phase switch component 20 after electrified should be able to drive the liquid crystal unit 23 to rotate so that the phase change of the liquid crystal unit 23 is large enough, for example, the liquid crystal unit 23 should be capable of altering between phase 0˜½λ in the embodiment with linear polarized lights and between phase ¼λ˜¾λ in the embodiment with circular polarized lights; hence, the voltage difference between the two conductive films 21, 22 is preferably between 4˜15 volts. Furthermore, the phase switch component 20 can also use optically compensate birefringence mode (OCB mode) or twisted nematic mode (TN mode) liquid crystal unit for quick response characteristics. It should also be noted that In other embodiments of the invention, without the second polarizer 12 implemented on the display panel 10, the phase switch component 20 can also be configured directly to the display panel 10, where a common substrate is shared by both the phase switch component 20 and the display panel 10 therebetween, and the first conductive film 21 is formed on the shared substrate.

Please refer to FIG. 3. FIG. 3 is a schematic diagram of an embodiment showing phase modulation of the display device 100. As the lights of a backlight module, which is not shown in the figure, goes along a light transmitting direction 13 through the first polarizer 11, the display panel 10, and the second polarizer 12, the outputted image signal is converted into linear polarized lights 3 having an angle θ with the horizontal axis. The linear polarized lights 3 injects into the phase switch component 20 and is modulated to have a changed polarization and forms a frame 15, an ejecting polarized lights 5, in FIG. 3, or not modulated by the phase switch component 20 and forms a frame 14, an ejecting polarized lights 4, in FIG. 3. In this embodiment, the ejecting polarized lights 4 and the ejecting polarized lights 5 are orthogonal with each other and outputted alternately. As one or more users wear linear polarized glasses 50 as shown in FIG. 3, a right part 52 of the glasses 50 has the same polarization as the ejecting polarized lights 4, which allows the users to perceive the content of the frame 14 with the right eyes. Likewise, a left part 51 of the glasses 50 has the same polarization as the ejecting polarized lights 5, which allows the users to perceive the content of the frame 15 with the left eyes. Given the alternately outputted orthogonal linear polarized lights for the left eyes and the right eyes from the 3-dimension display device 100, the users are able to properly perceive the visual effect of the 3-dimensional images. It is noted that the left part 51 and the right part 52 of the glasses 50 can be made of two polarized films or two polarized lens, which separately correspond to the left eye and the right eye.

Please refer to FIG. 4. FIG. 4 is a schematic diagram of another embodiment showing phase modulation of the display device 100. In this embodiment, the linear polarized lights 3 injects into the phase switch component 20 and is modulated to have a changed polarization and forms a frame 16, a counterclockwise circular polarized lights 6, in FIG. 4, or not modulated by the phase switch component 20 and forms a frame 17, a clockwise circular polarized lights 7, in FIG. 4. In this embodiment, the polarized lights 6 and the polarized lights 7 are orthogonal with each other and outputted alternately. As one or more users wear circular polarized glasses 60 as shown in FIG. 4, a right part 62 of the glasses 60 has the same polarization as the ejecting polarized lights 6, which allows the users to perceive the content of the frame 16 with the right eyes. Likewise, a left part 61 of the glasses 60 has the same polarization as the ejecting polarized lights 7, which allows the users to perceive the content of the frame 17 with the left eyes. Given the alternately outputted orthogonal circular polarized lights for the left eyes and the right eyes from the 3-dimension display device 100, the users are able to properly perceive the visual effect of the 3-dimensional images.

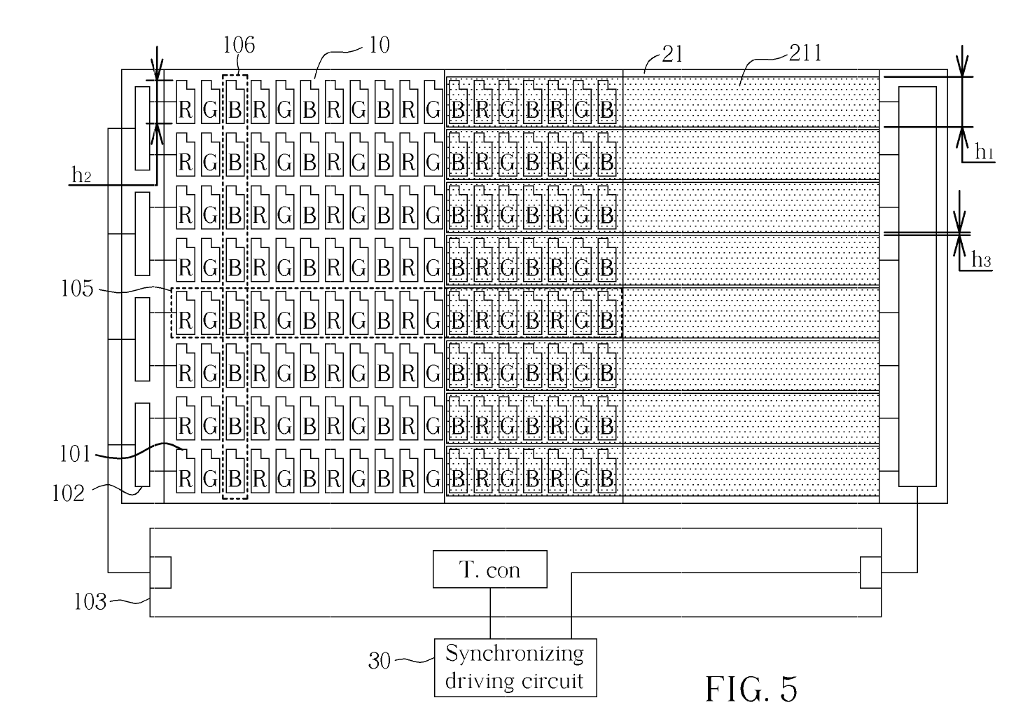

Please refer to FIG. 5, which is a block diagram showing portion of the display device 100. The display panel 10 includes a pixel matrix that has a plurality of pixel columns 106 aligning in parallel and a plurality of pixel rows 105 aligning in parallel. For example, each pixel row 105 includes a plurality of sequentially line-up red pixel (R), green pixel (G), and blue pixel (B). Each pixel has a pixel electrode 101 formed with transparent conductive layer (such as the indium tin oxide (ITO) material). According to the fact that the display panel 10 sequentially scans, or line scanning, from top to bottom, by the gate lines (or scan lines) so that the display data can be written to each pixel electrode 101 via data lines and TFTs, which are not shown, the phase switch component 20 (as shown in FIG. 1) of the invention is capable of modulating the polarized lights from the display panel 10 in real-time. Referring to both FIG. 1 and FIG. 5, the first conductive film 21 of the phase switch component 20 includes a plurality of mutually parallel, non-contacted parallel electrodes 211, whereas the second conductive film 22 is one single electrode to provide a steady reference voltage, such as, but not limited to, the ground level or a common voltage. FIG. 5 shows only the first conductive film 21 of the phase switch component 20 and for descriptive purpose, the first conductive film 21 is drawn distanced horizontally from the display panel 10, while for the real implementation, the first conductive film 21, the liquid crystal unit 23, and the second conductive film 22 of the phase switch component 20 are stacking over the whole light emitting side of the display panel 10. In this embodiment, the plurality of parallel electrodes 211 of the first conductive film 21 align not contacted with one another. Each parallel electrode 211 has a horizontal orientation and is distanced its neighboring parallel electrode 211 from a gap h₃, and has a width h₁ of its own. As FIG. 5 shows, each of the parallel electrodes 211 sequentially correspond to each of the pixel rows 105 of the display panel 10, which is, each parallel electrode 211 covers the plurality of pixel electrodes 101 of the corresponding pixel row 105. Please also refer to FIG. 1. The first conductive film 21 is preferably, but not limited to, configured at the side of the phase switch component 20 that faces the display panel 10 so as to allow the plurality of parallel electrodes 211 to precisely cover each corresponding pixel row 105.

Please go on referring to FIG. 5. The display panel 10 outputs 3-dimension images at a display frequency (or the frame rate), while the phase switch component 20 also switches the phase of the liquid crystal unit 23 at a modulating frequency. As mentioned above, the display panel 10 has the display data written to each pixel row 105 by line scanning, i.e., a control circuit 103 of the display device 100 controls each gate driver 102 to sequentially drive each pixel row 105 and have the display data written into the pixel electrodes 101 of each pixel row 105. The display device 100 further utilizes a synchronizing driving circuit 30 connected between the phase switch component 20 and the control circuit 103 for synchronizing the display frequency of the display panel 10 and the modulating frequency of the phase switch component 20. In other embodiments, the synchronizing driving circuit 30 can also be integrated into the T-con of the control circuit 103. Preferably in this invention, the display panel 10 displays the 3-dimension images at 120 Hz or above and the phase switch component 20 also modulates in synchronization with the display panel 10 at 120 Hz or above. In such way, each of the left part and the right part of the glasses can be provided with images with 60 Hz or above, which is a relatively stable images with quality.

Besides corresponding and covering each parallel pixel row 105, each parallel electrode 211 of the first conductive film 21 also has the width h₁ slightly larger than, or equal to, the width h₂ of the pixel electrodes 101 of the corresponding pixel row 105 in order to reduce the crosstalk effect. The area of each parallel electrode 211 is aligned and covers the corresponding pixel electrodes 101. Given each parallel electrode 211 not having contact with one another, the gap h₃ can be design to be between 0˜20 μm, and preferably between 10˜18 μm.

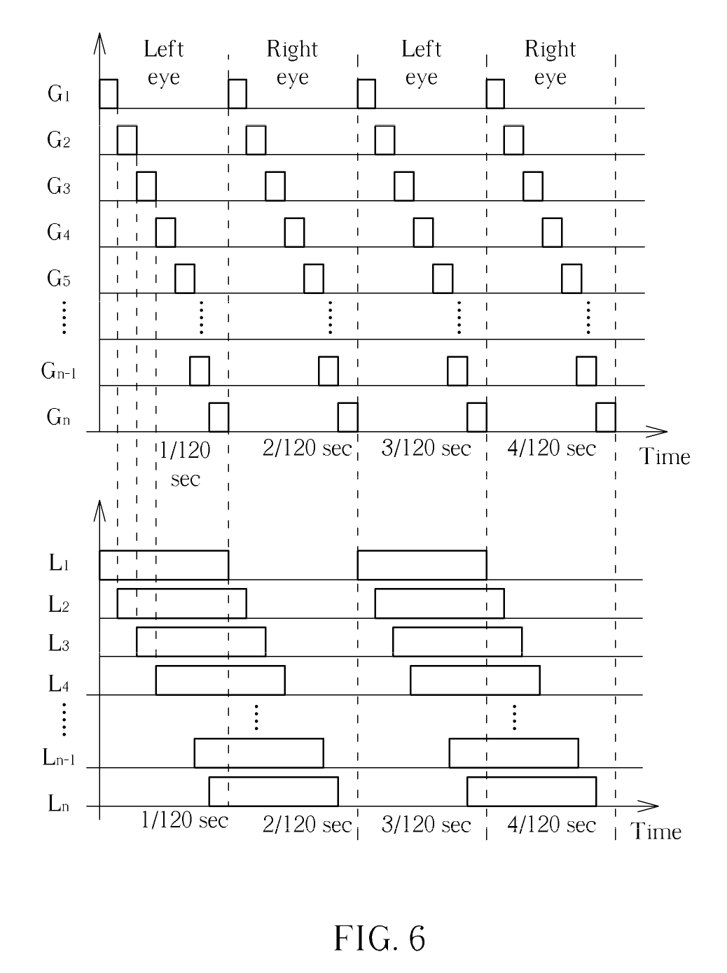

Please refer to FIG. 6. FIG. 6 is a schematic diagram showing the driving signals of the display device 100 in a time basis. In the embodiment of FIG. 6 for description, the display panel 100 of the display device 100 has n parallel pixel rows 105, which output left and right images at a frequency of 120 Hz. The first conductive film 21 of the phase switch component 20 has n rows of parallel electrodes 211, which also synchronously modulates the phase at a frequency of 120 Hz. Practically, each gate driver 102 corresponds to drive a plurality of gate lines, each corresponding to and driving a pixel row 105, where the plurality of pixel rows are driven sequentially. Hence, the gate lines G₁˜Gₙ of the display panel 10 sequentially drive the pixel electrodes 101 of corresponding pixel rows 105 by line scanning, while the phase switch component 20 also sequentially drives the parallel electrodes L₁˜Lₙ to switch the phase of the liquid crystal unit 23 by line scanning. For example, in a first display frame displayed during 0˜ 1/120 sec., or a left-eye frame, the gate line G₁ first drives the pixel electrodes 101 of the first pixel row 105 and the parallel electrode L₁ also synchronously drives the corresponding liquid crystal unit 23, which is placed between the parallel electrode L₁ and the second conductive film 22, to switch to phase P₁ and maintain as phase P₁ for 1/120 sec., which means during the interval of this 1/120 sec., a voltage difference is generated between the parallel electrode L₁ and the second conductive film 22, therefore having an effect to switch and maintain the liquid crystal unit 23 therebetween to phase P₁. Next, the gate line G₂ drives the pixel electrodes 101 of the second pixel row 105 and the parallel electrode L₂ also synchronously drives the corresponding liquid crystal unit 23, which is placed between the parallel electrode L₂ and the second conductive film 22, to switch to phase P₁ and maintain as phase P₁ for 1/120 sec., which means during the interval of this 1/120 sec., a voltage difference is generated between the parallel electrode L₂ and the second conductive film 22, therefore having an effect to switch and maintain the liquid crystal unit 23 therebetween to phase P₁. The rest follows until the gate line Gₙ drives the pixel electrodes 101 of the n^{th} pixel row 105 and the parallel electrode Lₙ also synchronously drives the corresponding liquid crystal unit 23, which is placed between the parallel electrode Lₙ and the second conductive film 22, to switch to phase P₁ and maintain as phase P₁ for 1/120 sec. Hence, the liquid crystal unit 23, which is placed between the first conductive film 21 and the second conductive film 22, is sequentially switched by each corresponding parallel electrode to phase P₁ and changes the polarization of the display frame outputted by the display panel 10 during 0˜ 1/120 sec. and the display frame can pass the left part of the glasses and is perceived by the left eye of a user.

In a second display frame displayed during 1/120˜ 2/120 sec., or a right-eye frame, the gate line G₁ first drives the pixel electrodes 101 of the first pixel row 105 and the parallel electrode L₁ also synchronously drives the corresponding liquid crystal unit 23, which is placed between the parallel electrode L₁ and the second conductive film 22, to switch to phase P₂ and maintain as phase P₂ for 1/120 sec., which means during the interval of this 1/120 sec., a voltage difference is generated between the parallel electrode L₁ and the second conductive film 22, therefore having an effect to switch and maintain the liquid crystal unit 23 to phase P₂. Next, the gate line G₂ drives the pixel electrodes 101 of the second pixel row 105 and the parallel electrode L₂ also synchronously drives the corresponding liquid crystal unit 23, which is placed between the parallel electrode L₂ and the second conductive film 22, to switch to phase P₂ and maintain as phase P₂ for 1/120 sec., which means during the interval of this 1/120 sec., a voltage difference is generated between the parallel electrode L₂ and the second conductive film 22, therefore having an effect to switch and maintain the liquid crystal unit 23 to phase P₂. The rest follows until the gate line Gₙ drives the pixel electrodes 101 of the n^{th} pixel row 105 and the parallel electrode Lₙ also synchronously drives the corresponding liquid crystal unit 23, which is placed between the parallel electrode Lₙ and the second conductive film 22 to switch to phase P₂ and maintain as phase P₂ for 1/120 sec. Hence, the liquid crystal unit 23, which is placed between the first conductive film 21 and the second conductive film 22, is sequentially switched by each corresponding parallel electrode to phase P₂ and changes the polarization of the display frame outputted by the display panel 10 during 1/120˜ 2/120 sec. and the display frame can pass the right part of the glasses and is perceived by the right eye of the user.

In such way, by using synchronous driving technology of the parallel electrodes of the phase switch component 20 and the gate drivers 102 of the display panel 10, the outputted 3-dimension images can be, in real time, modulated to correspond to the left part and the right part of the glasses alternately. Please also be noted that, during the driving process as shown in FIG. 6, the second conductive film 22 plays a role of providing a constant reference voltage during each driving interval for the left frames and the right frames, wherein the reference voltage can be, but not limited to, a ground voltage with zero level, a common voltage, or a constant bias voltage. In another embodiment, however, the voltage of the second conductive film 22 provided can also be a time-varying voltage.

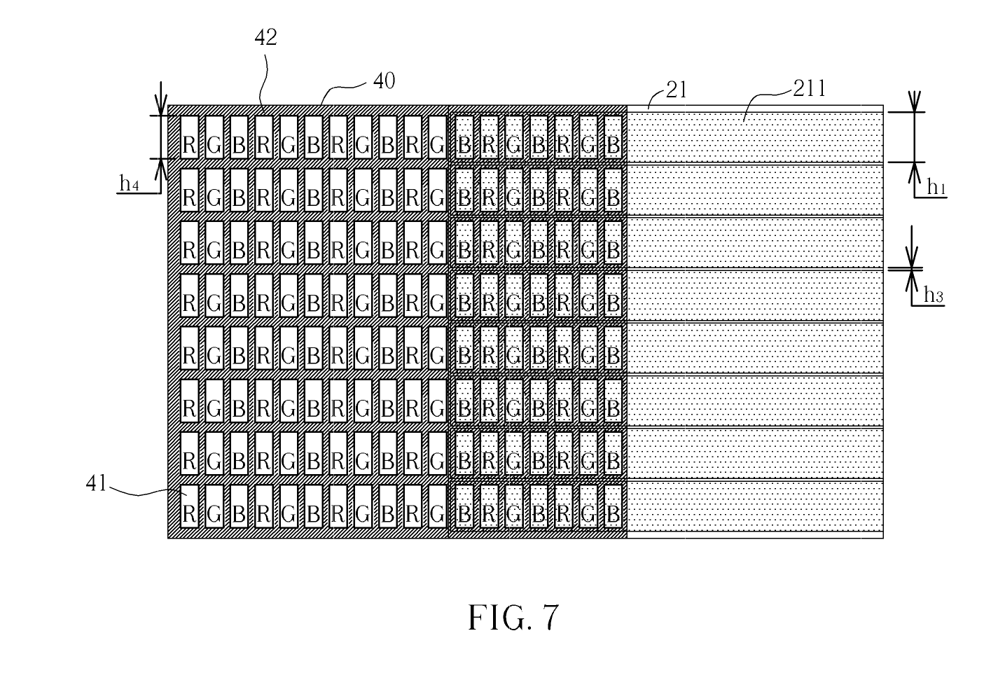

Additionally, although FIG. 5 shows an embodiment that the parallel electrodes 211 of the first conductive film 21 correspond and cover the pixel electrodes of the pixel rows 105 with width h₁ slightly larger than or equal to the width h₂ of corresponding pixel electrodes, in another embodiments of this invention, the display panel 10 may further include a color filter and each parallel electrode 211 corresponds to each parallel pixel filtering unit. Please refer to FIG. 7, which is a schematic diagram of the first conductive film 21 corresponding to a color filter 40 in the phase switch component 20. The color filter 40 has a black matrix 42 and a plurality of pixel filtering units 41, the R, G, B filtering units as shown in FIG. 7. Each parallel electrode 211 of the first conductive film 21 corresponds respectively to the pixel filtering units 41 of each row, and the width h₁ of the parallel electrodes 211 is slightly larger than the width h₄ of corresponding pixel filtering units 41 such that the parallel electrode 211 aligns and covers the pixel filtering units 41. Given the fact that the width h₄ of the pixel filtering units 41 is practically smaller than the width h₂ of the pixel electrodes 101, the width h₁ of the parallel electrodes 211 and the gap h₃ between every two parallel electrodes 211 can be implemented with more flexibility. The gap h₃ is then allowed to be increased to some extent as long as each parallel electrode has no contact with another one.

The 3-dimension display device of the invention utilizes the phase switch component driven synchronously, which is configured at the light emitting side of the display panel. The plurality of parallel electrodes is provided via the conductive film of the phase switch component, each corresponding to the pixel electrodes of one of a plurality of pixel rows, which are driven by gate drivers of the display panel. When the display panel sequentially drives the pixel electrodes of each pixel row, by line scanning way, to output frames of 3-dimension images, the phase switch component is synchronously driven to switch the phase of the liquid crystal unit within the phase switch component by each parallel electrodes and alters the frames to be polarized lights capable of being received by the left part and the right part of the 3D glasses respectively.

Those skilled in the art will readily observe that numerous modifications and alterations of the device and method may be made while retaining the teachings of the invention.

What is claimed is:

1. A 3-dimension display device, utilized for providing one or more pairs of polarized glasses to alternately receive a polarized lights corresponding to a left part and a right part of the polarized glasses, the display device comprising:
a display panel, comprising a plurality of pixel rows aligning in parallel, each pixel row comprising a plurality of pixel electrodes for outputting the polarized lights; and
a phase switch component configured at a light emitting side of the display panel, the phase switch component comprising a first conductive film, a second conductive film, and a liquid crystal unit, the first conductive film and the second conductive film configured at both sides of the liquid crystal unit respectively for being driven to switch the phase of the liquid crystal unit at a modulating frequency, the first conductive film comprising a plurality of parallel electrodes parallel and not in contact with one another, each of the parallel electrodes respectively corresponding to each of the pixel rows;
wherein a display frequency of the display panel is synchronous with the modulating frequency of the phase switch component, which switches the phase of the polarized lights outputted by the display panel alternately between a first phase and a second phase.

2. The display device of claim 1, wherein the first conductive film is configured at the side of the liquid crystal unit that faces the display panel.

3. The display device of claim 1, wherein each of the parallel electrodes of the first conductive film respectively covers the pixel electrodes of corresponding pixel row and the width of each parallel electrode is larger than the width of the corresponding pixel electrodes.

4. The display device of claim 1, wherein the display panel further comprises a color filter configured at a substrate of the display panel, the color filter comprising a plurality of rows of parallel pixel filtering unit, the plurality of parallel electrodes of the first conductive film corresponding and covering the plurality of rows of pixel filtering unit respectively, and the width of each parallel electrode larger than the width of the corresponding row of pixel filtering unit.

5. The display device of claim 1, wherein the plurality of parallel electrodes distance with one another from between 0˜20 μm.

6. The display device of claim 1, wherein the display frequency and the modulating frequency are larger than or equal to 120 Hz.

7. The display device of claim 1, wherein the phase switch component is an optically compensate birefringence mode (OCB mode) or twisted nematic mode (TN mode) liquid crystal display component.

8. The display device of claim 1, further comprising a synchronizing driving circuit electrically connected between the display panel and the phase switch component for synchronizing the display frequency of the display panel and the modulating frequency of the phase switch component.

9. The display device of claim 1, wherein the plurality of parallel electrodes are driven sequentially to switch and maintain the liquid crystal unit to the first phase or the second phase for a maintaining time, wherein the maintaining time is the inverse of the modulating frequency.

10. The display device of claim 1, wherein the polarized lights outputted by the display device are mutually orthogonal linear polarized lights, and the one or more pairs of polarized glasses are linear polarized glasses.

11. The display device of claim 1, wherein the polarized lights outputted by the display device are mutually orthogonal circular polarized lights, and the one or more pairs of polarized glasses are circular polarized glasses.

12. The display device of claim 1, wherein the first conductive film and the second conductive film are indium tin oxide (ITO) transparent conductive film.

13. A phase switch component, used for a 3-dimension display device and can be configured at a light emitting side of a display panel, which outputs a polarized lights and comprises a plurality of pixel rows, each pixel row comprising a plurality of pixel electrodes, the phase switch component comprising:
a first conductive film, comprising a plurality of parallel electrodes parallel with one another and each parallel electrode respectively corresponding to each of the pixel rows;
a second conductive film; and
a liquid crystal unit, configured between the first conductive film and the second conductive film, wherein the first conductive film and the second conductive film are driven to switch the phase of the liquid crystal unit at a modulating frequency;
wherein when the phase switch component is driven, a display frequency of the display panel is synchronous with the modulating frequency of the phase switch component, which switches the phase of the polarized lights outputted by the display panel alternately between a first phase and a second phase.

14. The phase switch component of claim 13, wherein the first conductive film is configured at the side of the liquid crystal unit that faces the display panel.

15. The phase switch component of claim 13, wherein each of the parallel electrodes of the first conductive film respectively covers the pixel electrodes of corresponding pixel row and the width of each parallel electrode is larger than the width of the corresponding pixel electrodes.

16. The phase switch component of claim 13, wherein the plurality of parallel electrodes distance with one another from between 0˜20 μm.

17. The phase switch component of claim 13, wherein the modulating frequency is larger than or equal to 120 Hz.

18. The phase switch component of claim 13, wherein the phase switch component is an optically compensate birefringence mode (OCB mode) or twisted nematic mode (TN mode) liquid crystal display component.

19. The phase switch component of claim 13, wherein the plurality of parallel electrodes are driven sequentially to switch and maintain the liquid crystal unit to the first phase or the second phase for a maintaining time, wherein the maintaining time is the inverse of the modulating frequency.

20. The phase switch component of claim 13, wherein the first conductive film and the second conductive film are indium tin oxide (ITO) transparent conductive film.
